(19) United States
(12) Patent Application Publication
(10) Pub. No.: US 2007/0229438 A1
(43) Pub. Date: Oct. 4, 2007

(54) Data driver and organic light emitting display using the same

(76) Inventor: Dong Yong Shin, Seoul (KR)

Correspondence Address: LEE & MORSE, P.C., 3141 FAIRVIEW PARK DRIVE, SUITE 500, FALLS CHURCH, VA, 22042, US

(21) Appl. No.: 11/706,401

(22) Filed: Feb. 15, 2007

(30) Foreign Application Priority Data
Apr. 4, 2006 (KR) 10-2006-0030746

(51) Int. Cl. G09G 3/36

(52) U.S. Cl. 345/99

(57) ABSTRACT

A data driver includes a shift register unit receiving a first clock signal, a second clock signal and a start pulse, and outputting a sampling pulse, a sampling latch unit storing data based on the sampling pulse and a charging signal, and a holding latch unit receiving data stored in the sampling latch unit based on a first enable signal and a second enable signal and supplying a first data signal or a second data signal to data lines based on the data received from the sampling latch unit.

### BACKGROUND OF THE INVENTION

1. Field of the Invention

The present invention relates to a data driver and an organic light emitting display using the same. More particularly, the present invention relates to a data driver configured of PMOS type transistors to be applicable when driving in a digital manner, and an organic light emitting display using the same.

2. Description of the Related Art

Various types of flat panel display devices are being developed, and flat panel display devices are more commonly replacing cathode ray tubes (CRTs). Flat panel display devices include liquid crystal displays (LCDs), field emission displays, plasma display panels (PDPs), and light emitting displays, etc. Flat panel display devices are capable of being lighter and thinner than CRTs.

More particularly, e.g., organic light emitting displays (OLEDs) generally display an image using an organic light emitting diode, which generates light by recombining electrons and holes. As a result, organic light emitting displays are generally advantageous relative to other types of flat panel displays because they may be driven with low power, i.e., may consume less power, and/or may have relatively fast response speeds.

An organic light emitting display may include pixels arranged in a matrix form, a data driver for driving data lines connected with the pixels, and a scan driver for driving scan lines connected with the pixels.

The data driver allows a predetermined image to be displayed by the pixels by supplying data signals during every horizontal period. The scan driver selects pixels to which respective data signals are supplied, by sequentially supplying scan signals during every horizontal period.

Larger, i.e., wider screen, flat panel display devices are desired. As panel sizes of organic light emitting displays become larger, i.e., wider, the data driver should be mounted on a panel in order to reduce a size, a weight and a manufacturing expense of the flat panel display. However, it is difficult for a conventional data driver including PMOS transistors and NMOS transistors to be mounted on the panel of a flat panel display. For example, in the case of organic light emitting displays OLEDs, PMOS devices may be better suited for improving pixel to pixel luminance uniformity than NMOS devices. For example, a need exists for a data driver, which includes only PMOS transistors and/or may be mountable on the panel.

### SUMMARY OF THE INVENTION

The invention is therefore directed to a data driver for driving pixels of a flat panel display, which substantially overcomes one or more of the problems due to the limitations and disadvantages of the related art.

It is an object of the invention to provide a data driver configured of PMOS type transistors to be applicable when driving in a digital manner, and an organic light emitting display using the same.

At least one of the above and other features and advantages of the present invention may be realized by providing a data driver, including a shift register unit receiving a first clock signal, a second clock signal and a start pulse and outputting a sampling pulse, a sampling latch unit storing data based on the sampling pulse and a charging signal, and a holding latch unit receiving data stored in the sampling latch unit based on a first enable signal and a second enable signal and supplying a first data signal or a second data signal to data lines based on the data received from the sampling latch unit.

The charging signal may have a high level when the data is input to the sampling latch unit. The shift register unit may include i shift registers, the i shift registers may sequentially generate the sampling pulse, wherein i is a natural number. The sampling latch unit may include i sampling latches and the holding latch unit may include i holding latches, wherein i is a natural number.

A phase of the first clock signal may be opposite to a phase of the second clock signal. The first clock signal and the second clock signal may both have a high level during at least one predetermined period of time.

Each of the shift register unit, the sampling latch unit and the holding latch unit may include a first transistor with a gate electrode connected to a second input terminal, a first electrode connected to an external input terminal, and a second electrode connected to a first node, a second transistor with a gate electrode connected to the first node, a first electrode connected to a first input terminal, and a second electrode connected to an output terminal, a third transistor with a gate electrode connected to the first input terminal, a first electrode connected to a second node, and a second electrode connected to one of a second power source and the first input terminal, a fourth transistor with a gate electrode connected to the first node, a first electrode connected with the second input terminal, and a second electrode connected to the second node, a fifth transistor with a gate electrode connected to the second node, a first electrode connected to a first power source, and a second electrode connected to the output terminal, and a capacitor connected between a gate electrode of the second transistor and the second electrode of the second transistor, wherein the first power source has a voltage higher than that of the second power source.

The first, second, third, fourth and fifth transistor may each be a p-type transistor. At least one of odd numbered ones of the shift registers receive the first clock signal through the first input terminal, and receive the second clock signal through the second input terminal, and even numbered ones of the shift registers receive the second clock signal through the first input terminal, and receive the first clock signal through the second input terminal.

The shift registers may charge a voltage corresponding to a voltage externally supplied in the capacitor when a low level voltage is supplied to the second input terminal, and supply a voltage corresponding to the voltage stored in the capacitor to the output terminal when a high level voltage is supplied to the second input terminal. The sampling latches may receive the sampling pulse through the second input terminal, and may receive the charging signal through the first input terminal.

The sampling latches may receive the data when the sampling pulse has a low level, and output the data when the sampling pulse is stopped and the charging signal has a high level. The holding latches may receive the first enable signal through the second input terminal, and receive the second enable signal through the first input terminal. A phase of the first enable signal may be opposite to a phase of the second enable signal.

The holding latches may receive data from the sampling latches when the first enable signal has a low level, and may supply a first data signal or a second data signal to data lines when the first enable signal has a high level.

The first enable signal may be sustained at a high level during a period that the data is stored into the sampling latches, and may be changed to a low level after the data is stored into the sampling latches.

Each of the holding latches may include an input unit controlling a voltage supplied to an output unit based on inverse data input to a third input terminal and at least one of the first and second enable signals, and an output unit controlling an output signal based the voltage supplied from the input unit, and the inverse data input to the third input terminal, wherein the first enable signal may be supplied through a first input terminal and the second enable signal may be supplied through a second input terminal. The inverse data may be supplied to each of the holding latches from the sampling latch unit.

The output unit may include an eleventh transistor with a first electrode connected a third power source and a second electrode connected to an output terminal of the output unit, a twelfth transistor with a first electrode connected to the output terminal of the output unit and a second electrode connected to a second power source having a voltage lower than the first power source, a thirteenth transistor with a gate electrode connected to a gate electrode of the eleventh transistor and a first electrode connected to the second electrode of the eleventh transistor, a fourteenth transistor with a first electrode connected to a second electrode of the thirteenth transistor, and a second electrode connected to one of the first input terminal or the second power source, a fifteenth transistor with a first electrode connected to the third input terminal, a second electrode connected with the gate electrode of the eleventh transistor, and a gate electrode connected to the first input terminal, a twelfth capacitor connected between the gate electrode of the eleventh transistor and the first electrode of the eleventh transistor, and an eleventh capacitor connected between a gate electrode of the twelfth transistor and the first electrode of the twelfth transistor.

The output unit may further include a fourteenth capacitor connected between the output terminal of the output unit and the second power source.

The input unit may include a sixteenth transistor with a first electrode connected with a gate electrode of the fourteenth transistor of the output unit and a second electrode connected with the first input terminal, a seventeenth transistor with a first electrode connected to a gate electrode of the sixteenth transistor, a gate electrode connected to the second input terminal, and a second electrode connected to one of the second input terminal or the second power source, an eighteenth transistor with a gate electrode connected to the third input terminal, a first electrode connected to one of the first input terminal and the first power source and a second electrode connected with the gate electrode of the sixteenth transistor, and a thirteenth capacitor connected between the gate electrode of the sixteenth transistor and the first electrode of the sixteenth transistor.

The eleventh, twelfth, thirteenth, fourteenth, fifteenth, sixteenth, seventeenth, and eighteenth transistors may be p-type transistors.

The sampling latch unit may include 3i sampling latches, and the holding latch unit includes 3i holding latches, wherein i is a natural number. The sampling latches may include red sampling latches for storing red data, green sampling latches for storing green data, and blue sampling latches for storing blue data, and the holding latches may include red holding latches receiving red data stored in the red sampling latches, green holding latches receiving green data stored in the green sampling latches, and blue holding latches receiving blue data stored in the blue sampling latches. At least one of the red, green and blue data are input to the holding latches as inverse phase data.

At least one of the above and other features and advantages of the present invention may be separately realized by providing a light emitting display including a scan driver sequentially supplying scan signals to scan lines, a data driver supplying a first data signal or a second data signal to respective data lines, and a plurality of pixels controlled to selectively emit light based on a respective one of the scan signals and the first data signal or the second data signal supplied thereto, wherein the data driver may include a shift register unit including shift registers including p-type transistors for sequentially supplying a sampling pulse, a sampling latch unit storing data based on the sampling pulse and a charging signal, and a holding latch unit receiving data stored in the sampling latch unit based on a first enable signal and a second enable signal, and supplying the first data signal or a second data signal to data lines based on external data supplied to the light emitting display.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a diagram of an organic light emitting display according to an exemplary embodiment of the invention;

FIG. 2 illustrates a diagram of one frame of an organic light emitting display according to an embodiment of the invention;

FIG. 3 illustrates a diagram of an exemplary embodiment of a pixel employable by the organic light emitting display shown in FIG. 1;

FIG. 4 illustrates a diagram of an exemplary embodiment of a data driver employable by the organic light emitting display shown in FIG. 1;

FIG. 5 illustrates a diagram of a first exemplary embodiment of a connection scheme for a shift register unit, a sampling latch unit and a holding latch unit employable by the data driver shown in FIG. 4;

FIG. 6 illustrates a waveform diagram according an exemplary embodiment of a driving method for driving the exemplary shift register unit, sampling latch unit and holding latch unit shown in FIG. 5;

FIG. 7 illustrates a circuit diagram of a first exemplary embodiment of a shift register of the exemplary shift register unit shown in FIG. 5;

FIG. 8 illustrates a circuit diagram of a first exemplary embodiment of a sampling latch of the exemplary sampling latch unit shown in FIG. 5;

FIG. 9 illustrates a circuit diagram of a first exemplary embodiment of a holding latch of the exemplary holding latch unit shown in FIG. 5;

FIG. 10 illustrates a circuit diagram of a second exemplary embodiment of a shift register, a sampling latch and a holding latch employable by a data driver employing the exemplary connection scheme illustrated in FIG. 5;

FIG. 11 illustrates a diagram of a second exemplary embodiment of a connection scheme for a shift register unit, a sampling latch unit and a holding latch unit employable by the data driver shown in FIG. 4;

FIG. 12 illustrates a waveform diagram according an exemplary embodiment of a driving method for driving the exemplary shift register unit, sampling latch unit and holding latch unit shown in FIG. 11;

FIG. 13 illustrates a circuit diagram of a first exemplary embodiment of a holding latch of the exemplary holding latch unit shown in FIG. 11;

FIG. 14 illustrates a waveform diagram explaining an operational process of the holding latch unit shown in FIG. 13;

FIG. 15 illustrates a circuit diagram of a second exemplary embodiment of a holding latch of the exemplary holding latch unit shown in FIG. 11;

FIG. 16 illustrates a circuit diagram of a third exemplary embodiment of a holding latch of the exemplary holding latch unit shown in FIG. 11;

FIG. 17 illustrates a circuit diagram showing a fourth exemplary embodiment of a holding latch of the holding latch unit shown in FIG. 11; and

FIG. 18 illustrates a diagram of a third exemplary embodiment of a connection scheme for a shift register unit, a sampling latch unit and a holding latch unit employable by the data driver shown in FIG. 4.

### DETAILED DESCRIPTION OF THE INVENTION

Korean Patent Application No. 10-2006-0030746, filed on Apr. 4, 2006, in the Korean Intellectual Property Office, and entitled: “Data Driver and Organic Light Emitting Display Using the Same,” is incorporated by reference herein in its entirety.

The invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or element, it can be directly on the other layer or element, or intervening layers may also be present. Further, it will be understood that when a layer is referred to as being “under” another layer or element, it can be directly under, and one or more intervening layers or elements may also be present. In addition, it will also be understood that when a layer or element is referred to as being “between” two layers or elements, it can be the only layer between the two layers or elements, or one or more intervening layers or elements may also be present. Like reference numerals refer to like elements throughout.

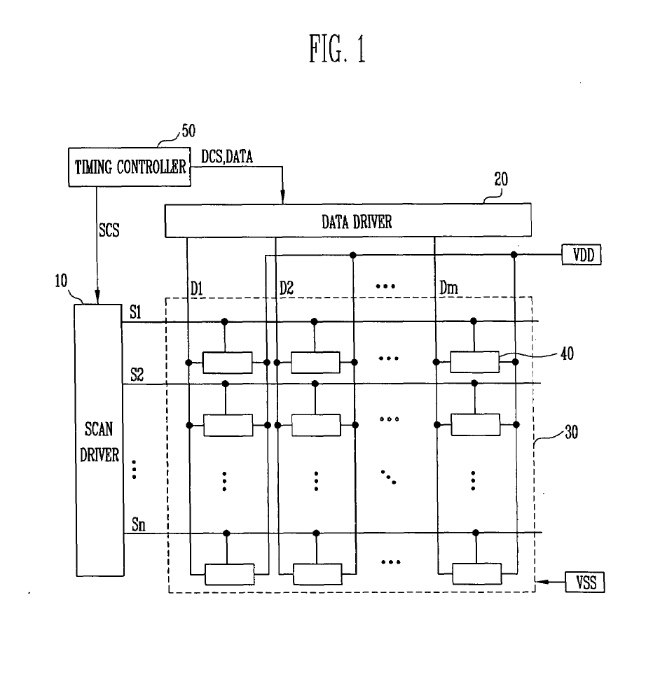

Hereinafter, exemplary embodiments of the invention, which can be carried out by those of ordinary skill in the art, will be described with reference to accompanying FIGS. 1 to 18.

FIG. 1 illustrates a diagram of an organic light emitting display according to an exemplary embodiment of the invention.

Referring to FIG. 1, an organic light emitting display according to an exemplary embodiment of the invention may include a pixel unit 30, a scan driver 10, and a data driver 20. The pixel unit 30 may include a plurality of pixels 40 connected with scan lines S1 to Sn and data lines D1 to Dm. The scan driver 10 may drive the scan lines S1 to Sn. The data driver 10 may drive the data lines D1 to Dm. The timing controller 50 may control the scan driver 10 and the data driver 20.

The timing controller 50 may generate a data driving control signal DCS and a scan driving control signal SCS based on externally supplied synchronizing signals. The data driving control signal DCS generated by the timing controller 50 may be supplied to the data driver 20, and the scan driving control signal SCS generated by the timing controller 50 may be supplied to the scan driver 10. The timing controller 50 may also supply externally supplied data DATA to the data driver 20.

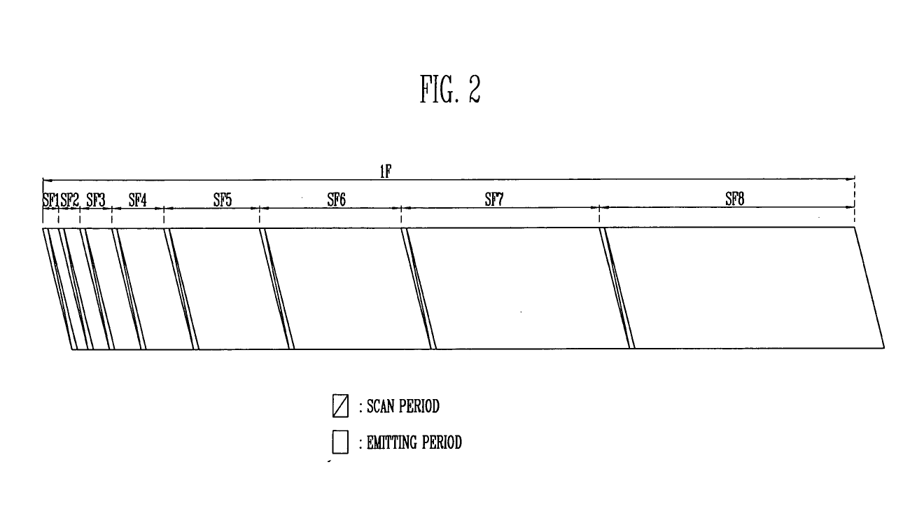

The data driver 20 may supply data signals, based on the externally supplied data DATA, to data lines D1 to Dm during each of the plurality of subframes, e.g., SF1 to SF8, included in one frame 1F (see FIG. 2). The data signals may include a first data signal corresponding to a state in which the pixels 40 emit light and a second data signal corresponding to a state in which the pixels 40 do not emit light. That is, the data driver 20 may supply the first data signal or the second data signal to the data lines D1 to Dm during each of subframe periods SF1 to SF8. Thus, during each of the subframe periods SF1 to SF8, whether the respective pixels 40 receive the first data signal or the second data signal may control whether or not the respective pixel 40 emits light during the respective one of the subframe periods SF1 to SF8.

The scan driver 10 may sequentially supply scan signals to the scan lines S1 to Sn during each of the subframe periods SF1 to SF8. If the scan signals are sequentially supplied to the scan lines S1 to Sn, the pixels 40 may be sequentially selected, e.g., a row at a time, and the selected pixels 40 may respectively receive the first data signal or the second signal supplied from the data lines D1 to Dm.

The pixel unit 30 may be connected to a first power source VDD and a second power source VSS, and may supply power from the first external power source and the second external power source to each of the pixels 40. The first power source VDD and/or the second power source VSS may be external power sources. When the scan signals are supplied, the data signals (the first data signal or the second data signal) may be supplied to each of the pixels 40 being supplied with the first power source VDD and the second power source VSS. Then, corresponding to supplied data signals, i.e., the first data signal or the second data signal, each of the pixels may or may not emit light during respective ones of each of the subframe periods SF1 to SF8.

FIG. 2 illustrates a diagram of one frame 1F of an organic light emitting display according to an embodiment of the invention. For the convenience of explanation, FIG. 2 illustrates one frame 1F divided into eight frames SF1 to SF8, however, the invention is not limited thereto.

Referring to FIG. 2, an organic light emitting display according to an embodiment of the invention may be driven by dividing one frame 1F into a plurality of subframes SF1 to SF8. Each of the subframes SF1 to SF8 may include a scan period and an emitting period, which, e.g., may be sequentially driven.

During the scan period, the scan signals may be sequentially supplied to the scan lines S1 to Sn. During the scan period, the data signals may be supplied to the data lines D1 to Dm to be synchronized with the scan signals. That is, during the scan period, the pixels 40, e.g., pixels in a row of the pixel unit 30, may to be turned on based on the respective data signals supplied thereto.

During the emitting period, based on the respective data signals supplied during the previous scan period, the pixels 40 may or may not emit light. The scan period may be set to be identical in each of the subframes SF1 to SF8, while the emitting period may be set to be different in each of the subframes SF1 to SF8. For example, a duration of the emitting period may increase by a ratio of, e.g., 2ⁿ (n=0, 1, 2, 3, 4, 5, 6, 7) from the first subframe SF1 to the eighth subframe SF8. That is, e.g., in embodiments of the invention, the pixels 40 of the pixel unit 30 may display an image of a predetermined gray scale based on the emitting or non-emitting state of each of the pixels 40 during each of the subframes SF1 to SF8 included in one frame 1F.

In embodiments of the invention, each of the subframes SF1 to SF8 included in one frame 1F may be changed in various ways. For example, one, some or all of the subframes SF1 to SF8 may include a reset period and/or the emitting period of each of the subframes SF1 to SF8 may be changed.

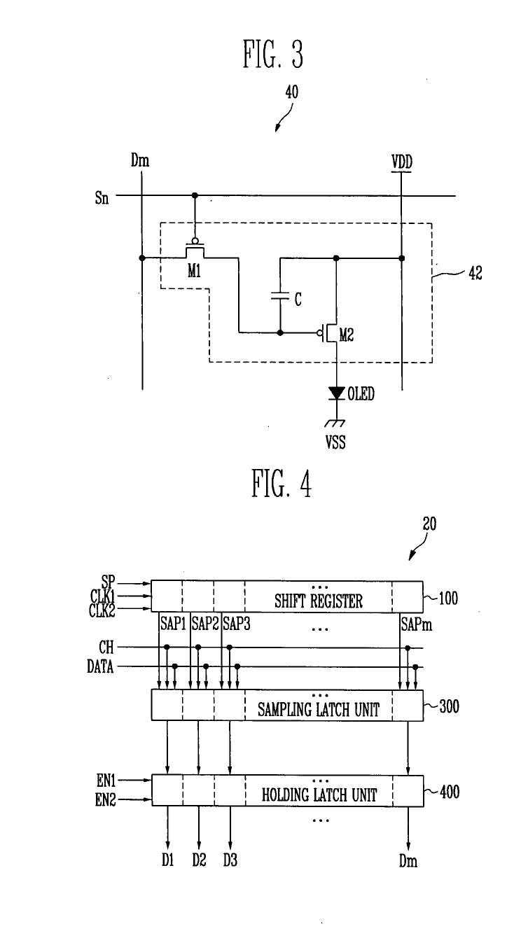

FIG. 3 illustrates a diagram of an exemplary embodiment of a pixel 40 employable by the organic light emitting display shown in FIG. 1. For the convenience of explanation, the nm-th pixel 40 connected with the n^{th} scan line Sn and the m^{th} data line Dm will be described in relation to FIG. 3. However, each of the pixels 40 of the pixel unit 30 may have a similar structure.

Referring to FIG. 3, in embodiments of the invention, the pixel 40 may include a pixel circuit 42 connected with an organic light emitting diode OLED, the corresponding data line Dm and the corresponding scan line Sn. Together with the pixel circuit 42 and the respective data and scan signals supplied thereto via the data line Dm and the scan line Sn during each of the subfields SF1 to SF8, the respective organic light emitting display OLED associated with the nm-th pixel 40 may or may not emit light during the respective subfields SF1 to SF8.

An anode electrode of the organic light emitting display OLED may be connected with the pixel circuit 42, and a cathode electrode of the organic light emitting display OLED may be connected with the second power source VSS. Such an organic light emitting display OLED may or may not emit light during each the subframes SF1 to SF8 based on respective currents supplied from the pixel circuit 42.

When the scan signals are supplied to the scan line Sn, the pixel circuit 42 may control whether or not the organic light emitting display OLED emits light based on the data signals supplied to the data line Dm. The pixel circuit 42 may include a first transistor M1, a second transistor M2, and a storage capacitor C. The first transistor M1 may be connected between the second transistor M2, the data line Dm and the scan line Sn. The second transistor M2 may be connected between the first power source VDD and the organic light emitting display OLED. The storage capacitor C may be connected between a gate electrode of the second transistor M2 and a first electrode of the second transistor M2.

A gate electrode of the first transistor M1 may be connected with the scan line Sn, and a first electrode of the first transistor M1 may be connected with the data line Dm. A second electrode of the first transistor M1 may be connected with a first terminal of the storage capacitor C. When the scan signals are supplied to the scan line during the scan period of each of the subframes SF1 to SF8, the first transistor M1 may be turned on to supply the data signals supplied to the data line Dm to the storage capacitor C. The first electrode of the first transistor M1 may be set to any one of a source electrode and a drain electrode, and the second electrode of the first transistor M1 may be set to the other of the source and drain electrodes. For example, if the first electrode of the first transistor M1 is set as the source electrode, the second electrode of the first transistor M1 may be set as the drain electrode.

The gate electrode of the second transistor M2 may be connected with the first terminal of the storage capacitor C, and a first electrode of the second transistor M2 may be connected with the second terminal of the storage capacitor C and the first power source VDD. A second electrode of the second transistor M2 may be connected with the organic light emitting diode OLED. The second transistor M2 may control whether or not the organic light emitting diode OLED emits light based on a corresponding voltage stored in the storage capacitor C. For example, when the voltage corresponding to the first data signal is charged in the storage capacitor C, the second transistor M2 may supply predetermined current(s) so that the organic light emitting diode OLED may emit light. When the voltage corresponding to the second data signal is charged in the storage capacitor C, the second transistor M2 may not supply current, and the organic light emitting diode OLED may not emit light.

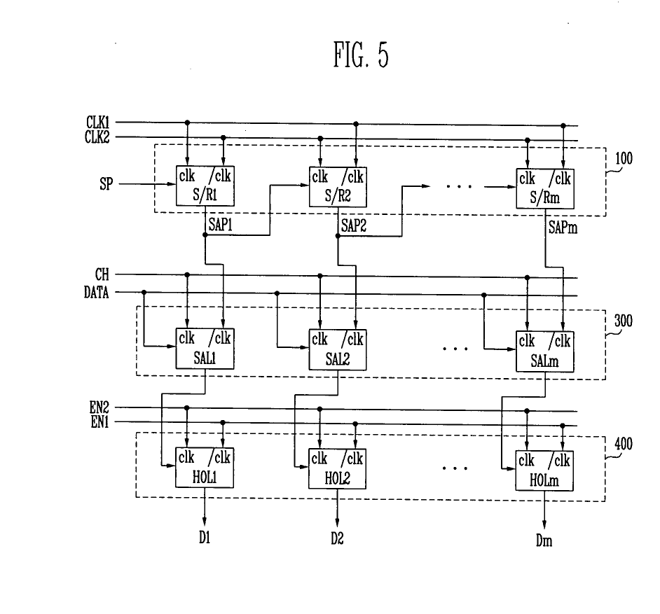

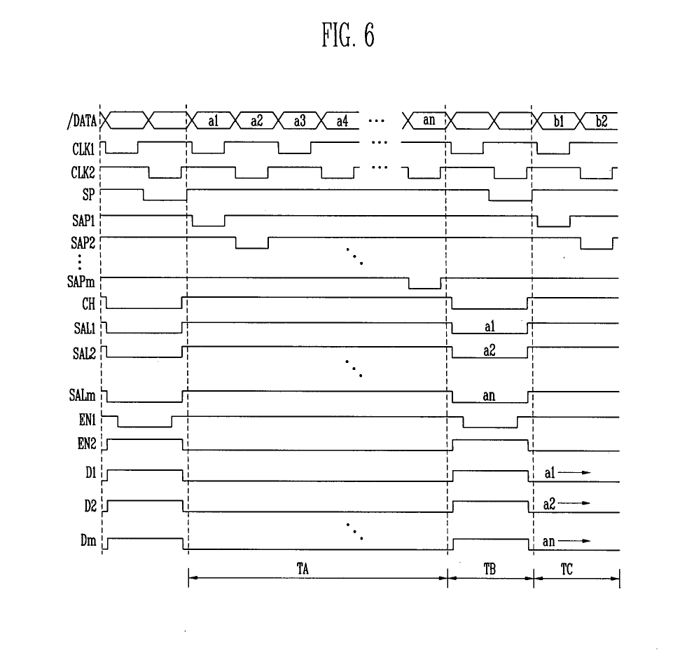

FIG. 4 illustrates a block diagram of an exemplary embodiment of the data driver 20 employable by the organic light emitting display shown in FIG. 1, FIG. 5 illustrates a diagram of a first exemplary embodiment of a connection scheme for a shift register unit 100, a sampling latch unit 300 and a holding latch unit 400 employable by the data driver 20 shown in FIG. 4, and FIG. 6 illustrates a waveform diagram according an exemplary embodiment of a driving method for driving the exemplary shift register unit 100, sampling latch unit 300 and holding latch unit 400 shown in FIG. 5.

Referring to FIG. 4, the data driver 20 employing one or more aspects of the invention may include the shift register 100, the sampling latch unit 300 and the holding latch unit 400.

The shift register 100 may sequentially generate a sampling pulse SAP based on a start pulse SP, a first clock signal CLK1 and a second clock signal CLK2. Referring to FIG. 5, the shift register 100 may include m shift registers S/R1 to S/Rm.

The sampling latch unit 300 may receive the sampling pulses SAP1 to SAPm, and a charging signal CH. Together with the sampling pulses SAP1 to SAPm and the charging signal CH, the sampling latch unit 300 may receive the respective data DATA, and may store the respective data DATA for a predetermined period of time. Referring to FIG. 5, the sampling latch unit 300 may include m sampling latches SAL1 to SALm. In embodiments of the invention, each of the sampling latches SAL1 to SALm may store one bit of the respective data DATA corresponding to the respective data line D1 to Dm.

The holding latch unit 400 may receive a first enable signal EN1 and a second enable signal EN2, and the m data, e.g., m bits of data, stored in the sampling latch unit 300. The holding latch unit 400 may simultaneously or substantially simultaneously receive the first enable EN1, the second enable EN2 and the m data stored in the sampling latch unit 300. The holding latch unit 400 may supply the supplied data to the data lines D1 to Dm as a data signal. Referring to FIG. 5, the holding latch unit 400 may include m holding latches HOL1 to HOLm.

An exemplary operation of the shift register unit 100, the sampling latch unit 300 and the holding latch unit 400 will be described below.

As discussed above and shown in FIG. 5, the shift register 100 may include m shift registers S/R1 to S/Rm. Odd numbered shift registers S/R1, S/R3, etc. of the shift registers S/R1 to S/Rm may receive the first clock signal CLK1 through a first input terminal clk, and may receive the second clock signal CLK2 through a second input terminal /clk. Even numbered shift registers S/R2, . . . S/Rm of the shift registers S/R1 to S/Rm may receive the second clock signal CLK2 through the first input terminal clk, and may receive the first clock signal CLK1 through the second input terminal /clk. The first clock signal CLK1 and the second clock signal CLK2 may have a phase difference of 180 degrees. In the exemplary embodiment shown in FIG. 6, the first clock signal CLK1 and the second clock signal CLK2 may include a number of overlapping portions.

The first shift register S/R1 of the shift registers S/R1 to S/Rm may generate a first sampling pulse SAP1 based on the first clock signal CLK1, the second clock signal CLK2 and the start pulse SP. The second shift register S/R2 of the shift registers S/R1 to S/Rm may generate a second sampling pulse SAP2 based on the first clock signal CLK1, the second clock signal CLK2, and the first sampling pulse SAP1.

In embodiments of the invention, the shift registers S/R1 to S/Rm may sequentially generate a sampling pulse SAP based on the sampling pulse SAP output by another one of the shift registers S/R1 to S/Rm or the start pulse SP.

For example, as shown in FIG. 5, in embodiments of the invention, the first shift register S/R1 may receive the start pulse SP for generating the first sampling pulse SAP1, the second shift register S/R2 may receive the first sampling pulse SAP1 output by the first shift register S/R1 for generating the second sampling pulse SAP2, and the mth shift register S/Rm may receive an m−1th sampling pulse SAP(m⁻¹) output by the (m−1)th shift register for outputting an mth sampling pulse SAPm. More particularly, for example, the second through mth shift registers S/R2 to S/Rm may respectively receive a respective sampling pulse SAP from the first to (m−1)th shift registers S/R1 to S/R(m−1).

The sampling latches SAL1 to SALm may receive a charging signal CH through a first input terminal clk, and may receive the respective sampling pulse SAP1 to SAPm through the second input terminal /clk. When the respective sampling pulse SAP1 to SAPm is supplied with the charging signal CH, the respective sampling latch SAL1 to SALm may receive the respective data DATA. For example, when the first sampling pulse SAP1 and the charging signal CH are supplied, the first sampling latch SAL1 may receive the respective data DATA, and may store the respective data DATA for a predetermined period. As shown in FIG. 6, in embodiments of the invention, the charging signal CH may be provided at a high level during a period when the data is input.

As discussed above, in some embodiments of the invention, each of the sampling latches SAL1 to SALm may store one bit of the respective data DATA corresponding to the respective data line D1 to Dm. In such embodiments, e.g., one bit of the data DATA corresponding to a high or low state may be respectively stored in each of the sampling latches SAL1 to SALm.

As discussed above, the holding latches HOL1 to HOLm may receive the second enable signal EN2 through the first input terminal clk, the first enable signal EN1 through the second input terminal /clk, and the respective data DATA stored in the sampling latches SAL1 to SALm. The holding latches HOL1 to HOLm of the holding latch unit 400 may simultaneously and/or substantially simultaneously receive the first enable signal EN1, the second enable signal EN2 and the respective data DATA, e.g., m bits of data, stored in the sampling latches SAL1 to SALm of the sampling latch unit 300.

For example, the respective one bit of the m data DATA may be supplied from the sampling latches SAL1 to SALm of the sampling latch unit 300 to the respective holding latches HOL1 to HOLm of the holding latch unit 400. The first holding latch HOL1 may receive the respective 1^{st} data DATA from the first sampling latch SAL1, a second holding latch HOL2 may receive the respective 2nd data DATA from the second sampling latch SAL2, and the mth holding latch HOLm may receive the respective mth data DATA from the mth sampling latch SALm.

The holding latches HOL1 to HOLm of the holding latch unit 400 may supply the respective data signals, e.g., the first data signal or second data signal, to the data lines D1 to Dm based on a polarity of the data DATA stored in the respective sampling latch SAL1 to SALm.

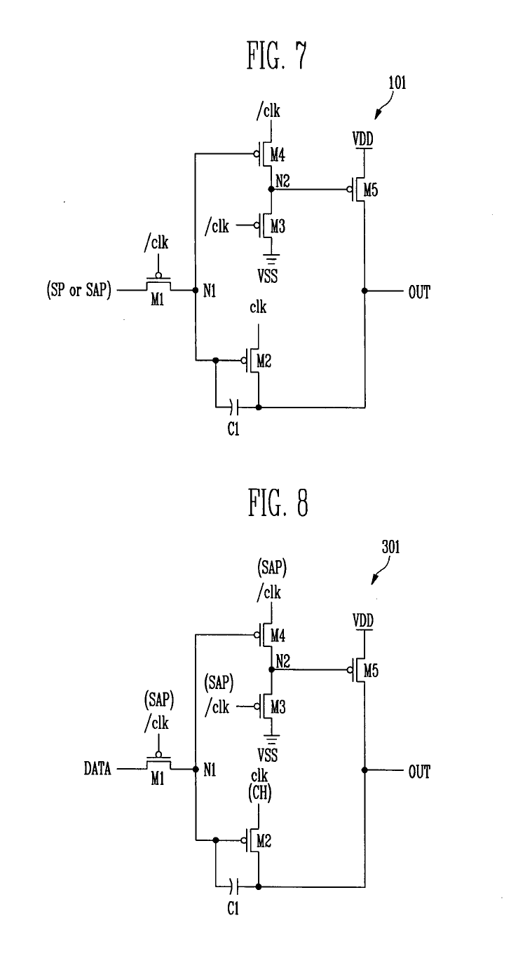

FIG. 7 illustrates a circuit diagram of a first exemplary embodiment of a shift register 101 employable by the shift register unit 100 shown in FIG. 5, according to one or more aspects of the invention. The exemplary shift register 101 may correspond to one, some or all of the shift registers S/R1 to S/Rm of the shift register unit 100 shown in FIG. 5.

Referring to FIG. 7, a shift register 101 according to an embodiment of the present invention may include first, second, third, fourth and fifth transistors M1, M2, M3, M4 and M5 and a capacitor C1. A first electrode of the first transistor M1 may be connected with an external input terminal or an output terminal OUT of another of the shift registers S/R1 to S/Rm. A second terminal of the first transistor M1 may be connected with a first node N1, and a gate terminal of the first transistor M1 may be connected to a second input terminal /clk.

A first terminal of the second transistor M2 may be connected to an output terminal OUT. A second terminal of the second transistor M2 may be connected to a second input terminal /clk, and a gate terminal of the second transistor M2 may be connected to the first node N1.

The capacitor C1 may have a first terminal connected to the first node N1, and a second terminal connected to the output terminal OUT.

The third transistor M3 may include a first terminal connected to a second node N2, and a second terminal connected to the second power source VSS. A gate terminal of the third transistor M3 may be connected to the second input terminal /clk.

A first terminal of the fourth transistor M4 may be connected to the second input terminal /clk, a gate terminal of the fourth transistor M4 may be connected to the first node N1, and a second terminal of the fourth transistor M4 may be connected to the second node N2.

A first terminal of the fifth transistor M5 may be connected to the first power source VDD. A second terminal of the fifth transistor M5 may be connected between to the output terminal out. A gate terminal of the fifth transistor M5 may be connected to the second node N2.

In embodiments of the invention, the first, second, third, fourth and fifth transistors M1, M2, M3, M4 and M5 may be P-type, e.g., PMOS, transistors. The first power source VDD may be set to be a higher voltage than second power source VSS.

Exemplary operation of the exemplary shift register 101 shown in FIG. 7 will be described below. The first electrode of the first transistor M1 may receive a start pulse SP or the sampling pulse SAP from another of the shift registers S/R1 to S/Rm. The first transistor M1 may be turned on or turned off based on a voltage state of the first clock signal CLK1 or the second clock signal CLK2 supplied to the second input terminal /clk.

The second transistor M2 may be turned on or turned off based on a voltage of the start pulse SP or the sampling pulse SAP output from another of the shift registers S/R1 to S/Rm, which may be supplied to the first node N1, i.e., the gate electrode of the second transistor M2, when the first transistor is turned on.

The third transistor M3 may be turned on or turned off based on a voltage state of the first clock signal CLK1 or the second clock signal CLK2 supplied to the second input terminal /clk. If the third transistor M3 is turned on, the relatively low voltage of the second power source VSS may be supplied to the second node N2. As discussed below, if a low voltage is applied, e.g., voltage of the second voltage source VSS, is applied to the gate terminal of the fifth transistor M5, the fifth transistor M5 may be turned on and a high voltage, e.g., voltage of the first voltage source VDD, may be applied to the output terminal OUT.

Similar to the second transistor M2, the fourth transistor M4 may be turned on or off based on a voltage of the first node N1. If the fourth transistor M4 is turned on, a voltage corresponding to a voltage state of the signal applied to the second input terminal /clk may be supplied to the second node N2.

The fifth transistor may be turned on or off based on a voltage supplied to the second node N2. More particularly, the fifth transistor M5 may be turned on if a low voltage is supplied to the second node N2 and thus, the high voltage of the first voltage source VDD may be supplied to the output terminal OUT.

When the first transistor M1 is turned on, the capacitor C1 may be charged with a voltage corresponding to a voltage of the start pulse SP or the sampling pulse SAP from an output terminal OUT of another of the shift registers S/R1 to S/Rm that was applied to the first node N1.

The following description of the exemplary embodiment of the shift register 101 illustrated in FIG. 7 assumes that the shift register 101 shown in FIG. 7 is a first shift register S/R1 of the plurality of shift registers S/R1 to S/Rm. Further, it will be assumed, for the convenience of explanation, that a low level voltage of the clock signals CLK1 and CLK2 is a voltage level corresponding to the second power source VSS, and a high level voltage thereof is a voltage level corresponding to first power source VDD. Here, the second power source VSS may be set to be a voltage lower than that of the first power source VDD. For example, the voltage of the second power source VSS may be a ground voltage GND.

Referring to FIG. 6, when the first clock signal CLK1 is at a high level state, the second clock signal CLK2 is at a low level state and a start pulse SP at a low level state is input, the first transistor M1 and the third transistor M3 receiving the second clock signal CLK2 of a low level may be turned on. If the first transistor M1 is turned on, the start pulse SP may be supplied to the first node N1. In this case, with the start pulse SP having the low level state, the second transistor M2 and the fourth transistor M4 may be turned on.

If the fourth transistor M4 is turned on, the second clock signal CLK2 of a low level may be input to the second node N2. Also, if the third transistor M3 is turned on, the low level of the second power source VSS may be supplied to the second node N2. Thus, as discussed above, if a low level voltage is applied to the gate of the fifth transistor M5, the fifth transistor may be turned on and a voltage of the first power source VDD may be supplied to the output terminal OUT. Meanwhile, if the second transistor M2 is turned on, the first clock signal CLK1 at a high level state may be supplied to the output terminal OUT.

During this time, the capacitor C1 may be charged with a voltage corresponding to a difference between a voltage at the first node N1 and a voltage at the output terminal OUT. In other words, the capacitor C1 may be charged with the voltage corresponding to the difference between a low voltage of the start pulse SP and the third power source VDD.

Thereafter, as shown in FIG. 6, the first clock signal CLK1 and the second clock signal CLK2 may change to a low level state and a high level state, respectively, and the start pulse SP may change to a high level state, i.e., the respective start pulse may stop. At this stage, the first transistor M1 and the third transistor M3 receiving the second clock signal CLK2 at a high level state may be turned off.

At this time, the first node N1 may be set to be a low level corresponding to the voltage charged in the capacitor C1. Then, the second transistor M2 may be turned on and thereby, the voltage of the output terminal OUT may drop to a voltage of a low level state of the first clock signal CLK1. As a result, as shown in FIG. 6, a first sampling pulse SAP1 having a low level signal corresponding to the low level state of the start pulse SP may be generated.

Meanwhile, if the first node N1 is set to be a low level, the fourth transistor M4 may be turned on. If the fourth transistor M4 is turned on, the second clock signal CLK2 of a high level may be supplied to the second node N2, and the fifth transistor M5 may be turned off.

Thereafter, the first clock signal CLK1 and the second clock signal CLK2 may change to a high level state and a low level state, respectively, and the start pulse SP may not be supplied. Then, the first transistor M1 and the third transistor M3, receiving the second clock signal CLK2 at a low level state, may be turned on. If the third transistor M3 is turned on, the voltage of the second power source VSS may be supplied to the second node N2, and the fifth transistor M5 may be turned on. If the fifth transistor M5 is turned on, the voltage of the first power source VDD may be supplied to the output terminal OUT accordingly.

In cases where the first transistor M1 is turned on, a high level signal corresponding to, e.g., a lack of a start pulse SP is supplied to the first node N1, the capacitor C1 may not be charged with a voltage. Accordingly, even though voltage states of first and second clock signals CLK1 and CLK2 may change, the second transistor M2 and the fourth transistor M4 may sustain an off state, and the shift register S/R1 may maintain a high level output at the output terminal OUT.

That is, when a low level voltage signal is supplied to the shift register 101, e.g., low level start pulse SP, the shift register S/R1 may store the low level voltage in the capacitor C1 during a first half of a period of the clock signals CLK1 and CLK2, and may output the voltage of a low level, e.g., corresponding to the sampling pulse SAP, during a second half of the period of the clock signals CLK1 and CLK2.

Meanwhile, when the first clock signal CLK1 and the second clock signal CLK2 are set to a low level and a high level, respectively, and the first sampling pulse SAP1 is input, a second shift register S/R2 may charge a voltage corresponding to the first sampling pulse SAP1 in the capacitor C1 of the second shift register S/R2. When the first clock signal CLK1 and the second clock signal CLK2 are inversed to a high level and a low level, respectively, the second shift register S/R2 may output a second sampling pulse SAP2. In embodiments of the invention, the shift registers S/R1 to S/Rm may sequentially output the sampling pulses SAP1 to SAPm, while repeating the process described above.

However, when both the first and the second clock signals CLK1 and CLK2 are at high level states, i.e., overlapped at a high level, a previous voltage supplied during a previous period during which the first clock signal CLK1 and the second clock signal CLk2 were at a low level state and a high level state, respective, e.g., a voltage output from a the previous shift register S/R1 to S/Rm. However, an output signal supplied to the output terminal OUT may be changed to a high level if, e.g., the first clock signal CLK1 and the second clock signal CLK2 were at a high level state and a low level state, respectively. Referring to FIG. 6, a gap or time delay may be generated between respective output pulses of subsequently operated ones of the shift registers S/R1 to S/Rm according to time periods during which the first and the second clock signals CLK1 and CLK2 overlap at a high level, e.g., periods during which both the first and second clock signal CLK1, CLK2 are at a high level state.

FIG. 8 illustrates a circuit diagram of a first exemplary embodiment of a sampling latch 301 employable by the sampling latch unit 300 shown in FIG. 5, according to one or more aspects of the invention. The exemplary sampling latch 301 may correspond to one, some or all of the sampling latches SAL1 to SALm of the sampling latch unit 300 shown in FIG. 5.

Referring to FIG. 8, in embodiments of the invention, each of the sampling latches SAL1 to SALm may have a same circuit structure as that of the exemplary shift register 101 shown in FIG. 7. However, a signal(s) supplied to one or more terminals of the sampling latch 301 may differ from those supplied to the exemplary shift register 101 shown in FIG. 7. Only differences between the exemplary sampling latch 301 and the exemplary shift register 101 will be described below.

For example, the sampling latch 301 may receive a charging signal CH through a first input terminal clk, and may receive a sampling pulse SAP through a second input terminal /clk.

An exemplary operation of the sampling latch 301 will be described below in conjunction with the exemplary waveform diagram shown in FIG. 6. Referring to FIG. 6, during a first period TA, when the first sampling latch signal SAP1 is set to be a low level while the charging signal CH is set to be a high level, the first sampling latch SAL1 may receive respective data DATA, e.g., high or low signal. The data DATA input to the first sampling latch SAL1 may be stored in the capacitor C1 of the sampling latch 301. Meanwhile, because the first sampling pulse SAP1 may be set to be a low level, the fifth transistor M5 may be turned on to output a high voltage corresponding to the first voltage source VDD at the output terminal OUT of the sampling latch 301.

Thereafter, if a supply of the first sampling pulse SAP1 is stopped, i.e., the first sampling pulse signal SAP1 changes to a high level state, and a supply of the charging signal CH is stopped, i.e., changed to a low level state, a voltage corresponding to the respective data DATA supplied while the first sampling pulse SAP1 was at a low level state, may be output to the output terminal OUT. For example, when a voltage of a low level is input as the respective data DATA, the voltage of a low level may be output to the output terminal OUT, and when a voltage of a high level is input as the respective data DATA, the voltage of a high level may be output to the output terminal OUT. Such a supply of signals may apply to the second to the m^{th} sampling latches SAL2 to SALm in the same manner.

More particularly, in embodiments of the invention, the sampling latches SAL1 to SALm of the invention may respectively receive the respective data DATA corresponding to the respective sampling pulse SAP1 to SAPm, and the charging signal CH, and may output a voltage corresponding to the respective data Data input thereto to the output terminal OUT thereof.

In embodiments of the invention, the charging signal CH may have a high level during the first period TA during which the data DATA may be respectively input, and may have a low level after input of the data DATA is completed, e.g., during time TB. Therefore, the sampling latches SAL1 to SALm receive the respective data DATA corresponding to the respective sampling pulse SAP1 to SAPm, and the charging signal CH, and may thereafter output a respective voltage corresponding to the respectively input data DATA to the output terminal OUT thereof during a subsequent time period, e.g., TB, after input of the respective data has been completed.

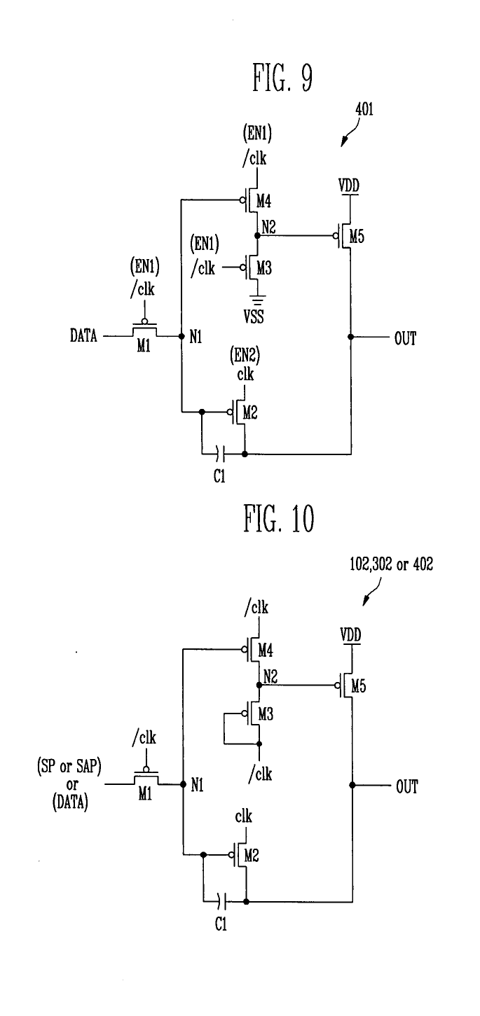

FIG. 9 illustrates a circuit diagram of a first exemplary embodiment of a holding latch 401 of the exemplary holding latch unit 400 shown in FIG. 5, according to one or more aspects of the invention. The exemplary holding latch 401 may correspond to one, some or all of the holding latches HOL1 to HOLm of the holding latch unit 400 shown in FIG. 5.

Referring to FIG. 9, in embodiments of the invention, each of the holding latches HOL1 to HOLm may have a same circuit structure as that of the exemplary shift register 101 shown in FIG. 7. However, a signal(s) supplied to one or more terminals of the sampling latch 401 may differ from those supplied to the exemplary shift register 101 shown in FIG. 7. Only differences between the exemplary holding latch 401 and the exemplary shift register 101 will be described below.

For example, the holding latches HOL1 to HOLm may receive a second enable signal EN2 through the first input terminal clk, and may receive a first enable signal EN1 through the second input terminal /clk.

An exemplary operation of the exemplary holding latch 410 will be described below in conjunction with the exemplary waveform diagram as shown in FIG. 6. After input of the respective data DATA into the respective sampling latches SAL1 to SALm is completed, i.e., after TA and during TB, the first enable signal EN1 may be set to be a low level, and the second enable signal EN2 may be set to be a high level. In embodiments of the invention, during TB, each of the holding latches HOL1 to HOLm may receive the respective data DATA included in each of the sampling latches SAL1 to SALm. For example, the respective data DATA input to the holding latches HOL1 to HOLm may be stored in the capacitor C1 included in each of the holding latches HOL1 to HOLm.

Thereafter, e.g., at the end of TB or during TC, the first enable signal EN1 may be set to be a high level, and the second enable signal EN2 may be set to be a low level. Then, each of the holding latches HOL1 to HOLm may supply a first data signal or a second data signal to each of the data lines D1 to Dm corresponding to the data stored in the respective holding latch HOL1 to HOLm. In embodiments of the invention TC may correspond to another period during which respective data DATA may be input to the sampling latches SAL1 to SALm, respectively.

The exemplary waveform shown in FIG. 6 will be described below with reference to the exemplary operation of the shift registers S/R, the sampling latches Sal and the holding latches HOL described above.

Odd numbered ones of the shift registers, e.g., S/R1, S/R3, may charge a voltage corresponding to the start pulse SP or the sampling pulse SAP of another of the shift registers S/R1 to S/Rm during a low level period of the second clock signal CLK2. The odd numbered ones of the shift registers may then output a voltage, e.g., a low level voltage, corresponding to the start pulse SP or the sampling pulse SAP of another of the shift registers S/R1 to S/Rm during a high level period of the second clock signal CLK2.

In embodiments of the invention, even numbered ones of the shift registers, e.g., S/R2, S/R4, may charge a voltage corresponding to the sampling pulse SAP of another of the shift registers S/R1 to S/Rm during a low level period of the first clock signal CLK1. The even numbered ones of the shift registers may then output a voltage, e.g., a low level voltage, corresponding to the start pulse SP or the sampling pulse SAP of another of the shift registers S/R1 to S/Rm during a high level period of the first clock signal CLK1. Therefore, as shown in FIG. 6, the shift registers S/R1 to S/Rm may sequentially generate the sampling pulses SAP1 to SAPm.

However, as described above, when both the first and the second clock signals CLK1 and CLK2 are at high level states, i.e., overlapped at a high level, a previous voltage supplied during a previous period during which the first clock signal CLK1 and the second clock signal CLk2 were at a low level state and a high level state, respective, e.g., a voltage output from a the previous shift register S/R1 to S/Rm. However, an output signal supplied to the output terminal OUT may be changed to a high level if, e.g., the first clock signal CLK1 and the second clock signal CLK2 were at a high level state and a low level state, respectively. Referring to FIG. 6, a gap or time delay may be generated between respective output pulses of subsequently operated ones of the shift registers S/R1 to S/Rm according to time periods during which the first and the second clock signals CLK1 and CLK2 overlap at a high level, e.g., periods during which both the first and second clock signal CLK1, CLK2 are at a high level state.

Also, when the charging signal CH is provided with a high level and the sampling pulse, i.e., any one of SAP1 to SAPm, which may correspond to a low level state thereof, is supplied to the respective sampling latch SAL1 to SALm, each of the sampling latches SAL1 to SALm may be charged with the respective data DATA. And, when the supply of the sampling pulse, i.e., any one of SAP1 to SAPm, is stopped, which may correspond to a high level period, along with the supply of the charging signal CH, which may correspond to a low level period, each of the sampling latches SAL1 to SALm may output the respective voltage corresponding to the charged data DATA.

Therefore, during the period TB, when the first enable signal EN1 is set to be at a low level and the second enable signal EN2 is set to be at a high level, each of the holding latches HOL1 to HOLm may receive the respective data DATA output from the sampling latches, i.e., any one of SAL1 to SALm. When the first enable signal EN1 is set at a high level and the second enable signal EN2 is at a low level, each of the holding latches HOL1 to HOLm may output the voltage of a high level or a low level to the data lines D1 to Dm corresponding to the respective data DATA stored therein. The high or low level voltage supplied to the data lines D1 to Dm may be supplied to pixels 40, as the first data signal or the second data signal.

That is, as described above, embodiments of the invention may implement a data driver 20 by using only P-type, e.g., PMOS transistors. If the data driver 20 is implemented as described above, it may be mounted on a panel, resulting in that the manufacturing expense can be reduced accordingly. Also, because embodiments of the data driver 20 employing one or more aspects of the invention may output the first data signal or the second data signal corresponding to the data DATA, embodiments of the invention may be employed when driving the data signals in a digital manner.

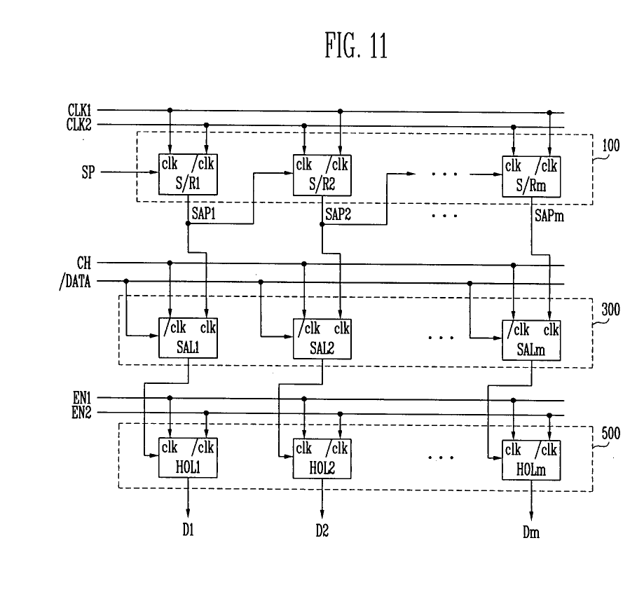

FIG. 10 illustrates a circuit diagram of a second exemplary embodiment of each of a shift register 102, a sampling latch 302 and a holding latch 402 employable by the data driver 20 employing the exemplary connection scheme illustrated in FIG. 5. In the following description of FIG. 10, only differences between the first exemplary embodiments of the shift register 101, the sampling latch 301 and the holding latch 401 and the second exemplary embodiments of the shift register 102, the sampling latch 302 and the holding latch 402 will be omitted below.

Referring to FIG. 10, in the second exemplary embodiment of the shift register 102, the sampling latch 302 and the holding latch 402, a gate electrode and a second electrode of the third transistor M3 may be connected with a second input terminal /clk. Even though the gate electrode and the second electrode of the third transistor M3 may be connected with the second input terminal /clk, operation of the second exemplary embodiments of the shift register 102, the sampling latch 302 and the holding latch 402 may be the same as that described with reference to the first exemplary embodiment of the shift register 101, the sampling latch 301 and the holding latch 401.

More particularly, e.g., the second electrode of the third transistor M3 of the shift register 101 shown in FIG. 7 may be connected with the second power source VSS. Therefore, in that case, when the third transistor M3 is turned on, the voltage of a low level is supplied to a gate electrode of a fifth transistor M5. Likewise, in the second exemplary embodiment of the shift register 102 shown in FIG. 10, when the voltage of a low level is supplied to the second input terminal /clk to turn on the third transistor M3, the voltage of a low level may be supplied to the gate electrode of the fifth transistor M5.

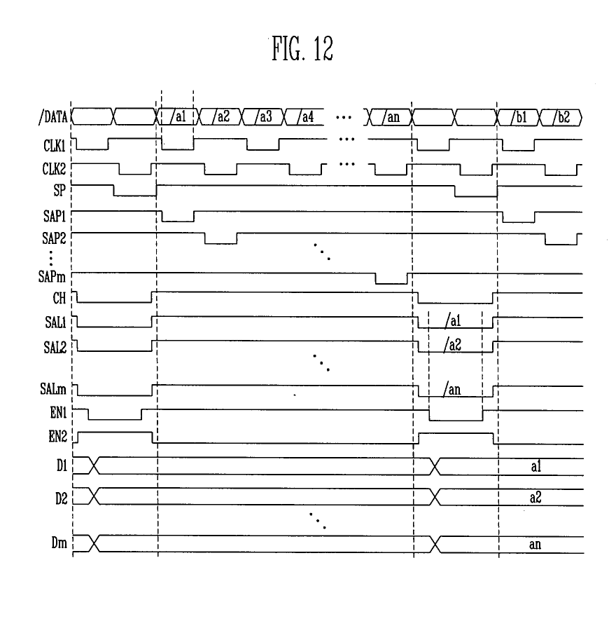

FIG. 11 illustrates a diagram of a second exemplary embodiment of a connection scheme for the shift register unit 100, the sampling latch unit 300 and a second exemplary embodiment of a holding latch unit 500 employable by the data driver 20 shown in FIG. 4, and FIG. 12 illustrates a waveform diagram according an exemplary embodiment of a driving method for driving the exemplary shift register unit 100, sampling latch unit 300 and holding latch unit 500 shown in FIG. 11.

In the following description of the second exemplary connection scheme illustrated in FIG. 11, only differences between the second exemplary embodiment and the first exemplary embodiment described above with reference to FIGS. 5 to 10 will be described. Thus, in the following description the same reference numerals will be used for like elements, and a detailed description of the like elements and/or the operation thereof will be omitted. More particularly, in the second exemplary connection scheme, each bit of the data DATA input to the sampling latch SAL1 to SALm is inversely input, i.e., /Data, and may include the second connection scheme includes the second exemplary embodiment of the holding latch unit 500.

Referring to FIG. 11, the data driver 20, shown in FIG. 4, may include the shift register 100 including m shift registers S/R1 to S/Rm, the sampling latch unit 300 including m sampling latches SAL1 to SALm, and a holding latch unit 500 including m holding latches HOL1 to HOLm.

In embodiments, odd numbered shift registers, e.g., S/R1, S/R3, of the shift registers S/R1 to S/Rm may receive the first clock signal CLK1 through a first input terminal clk, and may receive the second clock signal CLK2 through a second input terminal /clk. Even numbered shift registers, e.g., S/R2, S/R4, of the shift registers S/R1 to S/Rm may receive the second clock signal CLK2 through the first input terminal clk, and may receive the first clock signal CLK1 through the second input terminal /clk. In embodiments, the first clock signal CLK1 and the second clock signal CLK2 may have a phase difference of 180 degree. As discussed above, however, in embodiments, the first clock signal CLK1 and the second clock signal CLK2 may include predetermined overlapping portions during which both are at a high voltage level.

Therefore, the shift registers S/R1 to S/Rm may receive the start pulse SP or the sampling pulse SAP of another one of the shift registers S/R1 to S/Rm, and may sequentially generate the sampling pulse SAP as shown in FIG. 12.

The sampling latches SAL1 to SALm may receive the charging signal CH through the first input terminal clk, and may receive the sampling pulse SAP through the second input terminal /clk. The sampling latches SAL1 to SALm respectively receiving the sampling pulse SAP1 to SAPm and the charging signal CH may store the inverse phased data /DATA that is inversed per each bit, and may sustain the stored inverse phase data for a predetermined period. More particularly, e.g., when the first sampling pulse SAP1 and the charging signal CH are supplied, a first sampling latch SAL1 may receive the inverse phased data /Data and may store the inverse phased data /DATA for a predetermined period. When the second sampling pulse SAP2 and the charging signal CH are supplied, a second sampling latch SAL2 may receive the inverse phase data /Data and may store the inverse phase data /DATA for a predetermined period.

That is, e.g., the inverse phase data /Data of one bit having a high or a low state may be stored in each of the sampling latches SAL1 to SALm.

In embodiments of the invention, the charging signal CH may be provided with a high level during the period that the inverse phase data /Data may be input, as shown in FIG. 12.

The holding latches HOL1 to HOLm may receive a first enable signal EN1 through the first input terminal clk, and may receive a second enable signal EN2 through the second input terminal /clk. The holding latches HOL1 to HOLm receiving the first enable signal EN1 and the second enable signal EN2 may simultaneously or substantially simultaneously receive the inverse phase data /Data stored in the sampling latches SAL1 to SALm. The holding latches HOL1 to HOLm may allow the inverse phase data /DATA to be inversed again corresponding to a polarity of the stored inverse phase data /Data. According to the inverse phase data /DATA stored in the respective holding latch HOL1 to HOLm, the holding latches HOL1 to HOLm may supply the first data signal or the second data signal to the data lines D1 to Dm. In embodiments of the invention, a first holding latch HOL1 may receive the inverse phase data /DATA[1] of the first sampling latch SAL1, and a second holding latch HOL2 may receive the inverse phase data /DATA[2] of the second sampling latch SAL2.

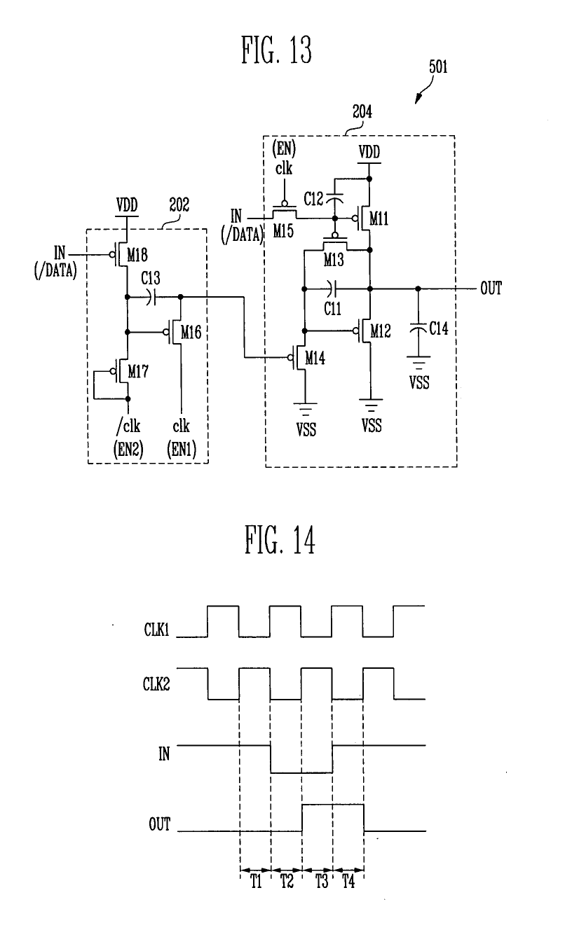

FIG. 13 illustrates a circuit diagram of a first exemplary embodiment of a holding latch 501 employable by the exemplary holding latch unit 500 shown in FIG. 11.

Referring to FIG. 13, each of the holding latches HOL1 to HOLm may include an input unit 202 and an output unit 204. In embodiments of the invention, eleventh through eighteenth transistors M11 to M18 that may be included in each of the holding latches HOL1 to HOLm may be a P-type, i.e., PMOS transistor.

The output unit 204 may control the data signals supplied to the data lines D1 to Dm corresponding to a voltage level, e.g., high level or low level, input from the input unit 202, a state of the first enable signal EN1 input to the first input terminal clk, and the inverse phase data /Data input to a third input terminal IN.

In embodiments of the invention, the output unit 204 may include a plurality of transistors, e.g., the eleventh through fourteenth transistors M11 to M14, and a plurality of capacitors, e.g., twelfth and fourteenth capacitors.

The eleventh transistor M11 may include a first terminal connected to the first power source VDD, a second terminal connected to an output terminal out OUT. The twelfth transistor M12 may include a first terminal connected to the output terminal OUT, and a second terminal connected to the second power source VSS. The thirteenth transistor M13 may include a first terminal connected to the output terminal OUT and a second terminal connected to a second terminal of the eleventh capacitor C11. A first terminal of the eleventh capacitor C11 may be connected to the output terminal OUT. The thirteenth transistor M13 and the eleventh capacitor C11 may be connected in parallel between a gate electrode and the first electrode of the twelfth transistor M12. That is, a second electrode of the eleventh capacitor C11 may be connected to the gate electrode of the twelfth transistor M12.

The fourteenth transistor M14 may include a first terminal connected to the gate terminal of the twelfth transistor M12 and a second terminal connected to the second power source VSS. A gate electrode of the fourteenth transistor M14 may be connected to an output node of the input unit 202. A first terminal of the fourteenth capacitor C14 may be connected to the output terminal OUT and a second terminal of the fourteenth capacitor C14 may be connected to the second power source VSS.

The fifteenth transistor M15 may include a first terminal connected to a gate electrode of the eleventh transistor M11 and a second terminal connected to the third input terminal IN. A first electrode of the twelfth capacitor C12 may be connected to the first power source VDD and a second terminal of the twelfth capacitor C12 may be connected to a gate electrode of the eleventh transistor M11, a gate electrode of the thirteenth transistor M12 and the first terminal of the fifteenth transistor M15.

Exemplary operation states of the transistors M11 to M15 and capacitors C11, C12 and C14 of the output unit 204 will be described below. When the fifteenth transistor M15 is turned on, the eleventh transistor M11 may be turned on or turned off based on a voltage input from the third input terminal IN or a voltage stored in the twelfth capacitor C12.

The twelfth capacitor C12 may be charged with a corresponding voltage to turn on or turn off the eleventh transistor M11. For example, when the eleventh transistor M11 is turned on, the twelfth capacitor C12 may be charged with a voltage for turning on the eleventh transistor M11, and when the eleventh transistor M11 is turned off, the twelfth capacitor C12 may be charged with a voltage for turning off the eleventh transistor M11.

The twelfth transistor M12 may be turned on or turned off based on a voltage applied to the gate electrode thereof. The eleventh capacitor C11 may be charged with a corresponding voltage for turning on or turning off the twelfth transistor M12. For example, when the twelfth transistor M12 is turned on, the eleventh capacitor C11 may be charged with a voltage for turn on the twelfth transistor M12, and when the twelfth transistor M12 is turned off, the eleventh capacitor C11 may be charged with a voltage for turning off the twelfth transistor M12.

The thirteenth transistor M13 may control a voltage supplied to the gate electrode of the twelfth transistor M12. The thirteenth transistor M13 may be simultaneously turned on or turned off with the eleventh transistor M11.

The fourteenth transistor M14 may control a voltage supplied to the gate electrode of the twelfth transistor M12. The fourteenth transistor M14 may be turned on or turned off based on a voltage supplied from the output node of the input unit 202.

The fifteenth transistor M15 may supply a voltage of the third input terminal IN to the gate electrode of the eleventh transistor M11. The fifteenth transistor M15 may be turned on or turned off based on the first enable signal EN1 input to the first input terminal clk.

The fourteenth capacitor C14 may be used to stabilize a voltage of the output terminal OUT.

Referring now to the input unit 202 illustrated in FIG. 13, the input unit 202 may supply a voltage of a high level or a low level to the output unit 204 based on a voltage supplied to the first input terminal clk, the second input terminal /clk and the third input terminal IN, i.e., the inverse phase data /DATA.

In embodiments of the invention, the input unit 202 may include a plurality of transistors, e.g., sixteenth through eighteenth transistors M16 to M18, and a capacitor, e.g., thirteenth capacitor C13.

The eighteenth transistor M18 may have a gate terminal connected to the third input terminal IN, a first terminal connected to the first power supply VDD, and a second terminal connected to a second terminal of the thirteenth capacitor C13, a gate terminal of the sixteenth transistor M16, and a first terminal of the seventeenth transistor M17. A first terminal of the thirteenth capacitor may be connected to a first terminal of the sixteenth transistor M16, which may correspond to the output node of the input unit 202 that connects to the gate of the fourteenth transistor M14 of the output unit 204. A second terminal of the sixteenth transistor M16 may be connected to the first input terminal clk. A gate electrode and second terminal of the seventeenth transistor M17 may both be connected to the second input terminal /clk.

Exemplary operation states of the sixteenth to eighteenth transistors M16 to M18, and the thirteenth capacitor C13 of the input unit 202 will be described below. The sixteenth transistor M16 may be turned on or turned off based on a voltage supplied to the third input terminal IN, the second input terminal /clk or the thirteenth capacitor C13.

The eighteenth transistor M18 may be turned on or turned off based on a voltage supplied to the third input terminal IN.

The thirteenth capacitor C13 may be charged with a corresponding voltage for turning on or turning off the sixteenth transistor M16. For example, when the sixteenth transistor M16 is turned on, the thirteenth capacitor C13 may be charged with a voltage for turning on the sixteenth transistor M16, and when the sixteenth transistor M16 is turned off, the thirteenth capacitor C13 may be charged with a voltage for turning off the sixteenth transistor M16.

The seventeenth transistor M17 may be diode-connected, i.e., gate electrode connected to drain electrode thereof, and may be turned on or turned off based on the second enable signal EN2 supplied to the second input terminal /clk.

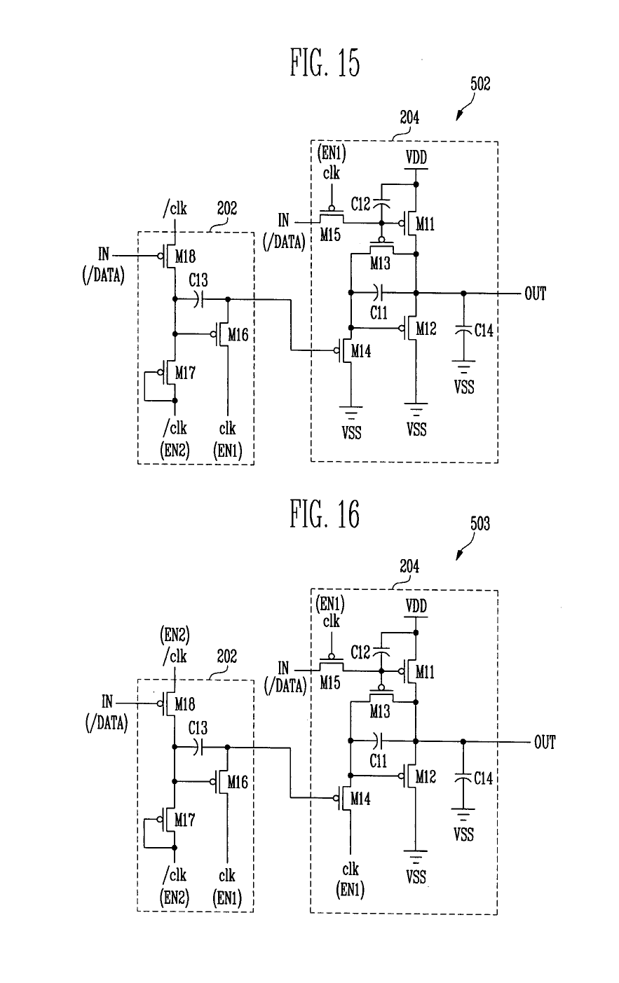

FIG. 14 illustrates a waveform diagram explaining an operation process of the holding latch unit 501 shown in FIG. 13. In FIG. 14 it will be assumed that a first clock signal CLK1 is supplied to the first input terminal clk, and a second clock signal CLK2 is supplied to the second input terminal /clk. An exemplary operation process of the holding latch unit 501 shown in FIG. 13 will be described below in view of the exemplary waveforms illustrated in FIG. 14.

Referring to FIG. 14, during a first period T1, a low level, a high level and a high level may be respectively input to the first input terminal clk, the second input terminal /clk and the third input terminal IN. If the voltage of a high level is input to the third input terminal IN and the second input terminal /clk, the seventeenth transistor M17 and the eighteenth transistor M18 may be turned off. Depending on a voltage stored in the thirteenth capacitor C13, the sixteenth transistor M16 may be turned on. If the sixteenth transistor M16 is turned on, the low level voltage supplied to the first input terminal clk may be output to the output node of the input unit 202.

Meanwhile, if the low level voltage supplied to the first input terminal clk is output to the output end of the input unit 202, the fourteenth transistor M14 may be turned on. The fifteenth transistor M15 may also be turned on by corresponding to the voltage of a low level supplied to the first input terminal clk. If the fifteenth transistor M15 is turned on, the voltage of a high level supplied to the third input terminal in is supplied to the gate electrode of the eleventh transistor M11 and the thirteenth transistor M13. In this case, the eleventh transistor M11 and the thirteenth transistor M13 are turned off, and accordingly, the twelfth capacitor C12 is charged with the voltage corresponding to a turn off state of the eleventh transistor M11 and the thirteenth transistor M13.

If the fourteenth transistor M14 is turned on, the low voltage of the fourth power source VSS may be supplied to the gate electrode of the twelfth transistor M12. If the voltage of the fourth power source VSS is supplied to the gate electrode of the twelfth transistor M12, the twelfth transistor M12 may be turned on, and accordingly, the eleventh capacitor C11 may be charged with the voltage corresponding to a turn on state of the twelfth transistor M12. Meanwhile, if the twelfth transistor M12 is turned on, the voltage of a low level may be output to the output terminal OUT during the first period T1.

During a second period T2, a high level voltage, a low level voltage, and a low level voltage may be respectively input to the first input terminal clk, the second input terminal /clk and the third input terminal IN.

If a low level voltage is input to the second input terminal /clk, the seventeenth transistor M17 may be turned on. If a low level voltage is input to the third input terminal IN, the eighteenth transistor M18 may be turned on. In such cases, the sixteenth transistor M16 may be turned on as a result of the low level voltage input to the seventeenth transistor M17, and accordingly, the high level voltage input to the first input terminal clk may be output to the output node of the input unit 202. In such cases, during the second period D2, the thirteenth capacitor C13 may be charged with a voltage corresponding to a turn on state of the sixteenth transistor M16.

Meanwhile, if the voltage of a high level is output to the output end of the input unit 202, the fourteenth transistor M14 is turned off. And, the fifteenth transistor M15 is turned off by corresponding to the voltage of a high level supplied to the first input terminal clk.

If the fifteenth transistor M15 is turned off, the eleventh transistor M11 and the thirteenth transistor M13 may be turned off by corresponding to the turn off voltage stored in the twelfth capacitor C12. If the fourteenth transistor M14 is turned off, the twelfth transistor M12 may be turned off based on a turn off voltage stored in the eleventh capacitor C11. Then, the voltage of a low level may be output to the output terminal OUT. That is, in embodiments of the invention, the voltage of the output terminal OUT during the first period T1 may be sustained during the second period T2.

During a third period T3, a low level voltage, a high level voltage, and a low level voltage may be respectively supplied to the first input terminal clk, the second input terminal /clk and the third input terminal IN.

If the high level voltage is input to the second input terminal /clk, the seventeenth transistor M17 may be turned off. If the low level voltage is input to the third input terminal IN, the eighteenth transistor M18 may be turned on. Then, a gate voltage of the sixteenth transistor M16 may rise to the voltage of the first power source VDD. If the gate voltage of the sixteenth transistor M16 rises to the voltage of the first power source VDD, the first electrode of the sixteenth transistor M16 may not drop below the voltage of the first power source VDD, and accordingly, the fourteenth transistor M14 may be turned off.

Meanwhile, the fifteenth transistor M15 may be turned on based on the low level voltage supplied to the first input terminal clk. If the fifteenth transistor M15 is turned on, the low level voltage input to the third input terminal IN may be supplied to the gate electrodes of the eleventh transistor M11 and the thirteenth transistor M13. Then, the eleventh transistor M11 and the thirteenth transistor M13 may be turned on. In such cases, the twelfth capacitor C12 may be charged with a voltage corresponding to a turn on state of the eleventh transistor M11.

If the eleventh transistor M11 is turned on, the voltage of the first power source VDD may be supplied to the output terminal OUT. That is, the voltage of a high level may be output to the output terminal OUT. If the thirteenth transistor M13 is turned on, the first power source VDD voltage may be supplied to the gate electrode of the twelfth transistor M12 and accordingly, the twelfth transistor M12 may be turned off. In such cases, the eleventh capacitor C11 may be stored with a voltage corresponding to a turn off state of the twelfth transistor M12.

During a fourth period T4, a high level voltage, a low level voltage, and a high level voltage may be respectively input to the first input terminal clk, the second input terminal /clk and the third input terminal IN.

If the low level voltage is input to the second input terminal /clk, the seventeenth transistor M17 may be turned on. If the high level voltage is input to the third input terminal IN, the eighteenth transistor M18 may be turned off. Then, a low level voltage input to the second input terminal /clk may be supplied to the sixteenth transistor M16 and accordingly, the sixteenth transistor M16 may be turned on. If the sixteenth transistor M16 is turned on, the high level voltage supplied to the first input terminal clk may be supplied to the fourteenth transistor M14 and accordingly, the fourteenth transistor M14 may be turned off.

Meanwhile, the fifteenth transistor M15 may be turned off based on the high level voltage supplied to the first input terminal clk. If the fifteenth transistor M15 is turned off, the eleventh transistor M11 and the thirteenth transistor M13 may be turned on based on the voltage stored in the twelfth capacitor C12. If the fourteenth transistor M14 is turned off, the twelfth transistor M12 may be turned off based on the voltage stored in the eleventh capacitor C11. That is, during the fourth period T4, a high level voltage corresponding to the high level voltage output during the third period T3 may be output at the output terminal OUT.

In general, the exemplary holding latch unit 501 may operate such that when a low level voltage is input to the first input terminal clk, a voltage having a level opposite to a voltage level at the third input terminal IN may be supplied to the output terminal OUT, and when a high level voltage is input to the first input terminal clk, the voltage at the output terminal OUT during a previous period may be sustained.

Referring to FIGS. 11 and 12, when the first enable signal EN1 input to the first input terminal clk is input at a low level and the second enable signal EN2 input to the second input terminal /clk is input at a high level, the inverse phase data /DATA input to the third input terminal IN may be inversed again and therefore, the holding latch 501 may output the data DATA. When the first enable signal EN1 input to the input terminal clk is input at a high level and the second enable signal EN2 input to the second input terminal /clk is input at a low level, the holding latch 510 may sustain output of the data DATA, i.e., the inverse phase data inversed back to its original phase.

Thus, in embodiments of the invention, the holding latches HOL1 to HOLm enable the inverse phase data /DATA that may be input thereto to be inversed back to its original phase as, i.e., DATA, such that data signals as the first data signal or the second data signal corresponding to the data DATA may be output to the data lines D1 to Dm based on a polarity of the respective input inversion data /Data.

FIG. 15 illustrates a circuit diagram of a second exemplary embodiment of a holding latch 502 employable by the exemplary holding latch unit 500 shown in FIG. 11. In the following description of the exemplary circuit diagram of the holding latch 502, only differences between the first exemplary holding latch 501 and the second exemplary holding latch 502 will be described. The first and second exemplary holding latches 501, 502 may have a same circuit structure, and may only differ with regard to signals supplied thereto.

Referring to FIG. 15, the first electrode of the eighteenth transistor M18 of the holding latch 502 may be connected with the second input terminal /clk. As discussed above, in the first exemplary latch 501 shown in FIG. 13, the first electrode of the eighteenth transistor M18 may be connected to first power source VDD, while in the second exemplary holding latch 502, the first electrode of the eighteenth transistor M18 may be connected to the second input terminal /clk.

As for operation of the second exemplary holding latch 502, during the first period T1, the eighteenth transistor M18 may be turned off by supplying a high level voltage to the third input terminal IN connected to the gate electrode of the eighteenth transistor M18. The eighteenth transistor M18 may be turned off by supplying a low level voltage to the

During the second period T2, the eighteenth transistor M18 may be turned on by supplying a low level voltage to the third input terminal IN. Referring to FIG. 14, because a low level voltage may be supplied to the second input terminal /clk during the second time T2, the seventeenth transistor M17 may be turned on. As a result, a low level corresponding to the low level of the second clock signal CLK2 may be supplied to the gate electrode of the sixteenth transistor M16 via the seventeenth transistor M17 and the eighteenth transistor M18 in an on state. Thus, during the second period T2, the sixteenth transistor M16 may be turned on and a high level voltage applied to the first input terminal clk may be supplied via the sixteenth transistor M16 to the output node of the input unit 202.

Meanwhile, in the second exemplary holding latch 502, when the seventeenth transistor M17 and the eighteenth transistor M18 are simultaneously on during the second period T2, both are supplied with the second clock signal CLK2 that may be input to the second input terminal /clk. Thus, in the second exemplary holding latch 502, power consumption may be reduced. More particularly, in the first exemplary holding latch 501 shown in FIG. 13, when the seventeenth transistor M17 and the eighteenth transistor M18 are simultaneously on, the first power source VDD and the second input terminal /clk are connected, which may result in high power consumption. However, in the second exemplary holding latch 502, power consumption may be reduced because the first power source VDD is omitted.

During the third period, a low level voltage may be input to third input terminal IN to turn on the eighteenth transistor M18. If the eighteenth transistor M18 is turned on, a high level voltage corresponding to the second clock signal CLK2 supplied to the second input terminal /clk during the third period T3 may be supplied to the gate electrode of the sixteenth transistor M16, and the sixteenth transistor M16 may be off during the third period T3. Thus, the voltage at the output node of the input unit 202 may remain at a high level, and thus, the fourteenth transistor M14 may be turned off.

During the fourth period T4, a high level voltage may be input to the third input terminal IN to turn off the eighteenth transistor M18.

As described above, the second exemplary holding latch 502 may be driven in the same manner as the first exemplary holding latch 501. However, in the second exemplary holding latch 501 may enable lower power consumption when the seventh transistor M17 and the eighteenth transistor M18 are simultaneously turned on.

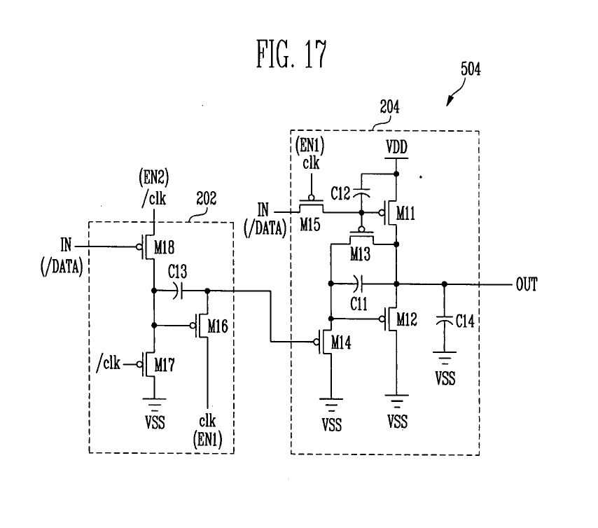

FIG. 16 illustrates a circuit diagram of a third exemplary embodiment of a holding latch 503 employable by the exemplary holding latch unit 500 shown in FIG. 11. In the following description of the third exemplary holding latch 503, only differences between the third exemplary holding latch 503 and the first and second exemplary holding latches 501, 502 shown in FIGS. 13 and 15 will be described.

Referring to FIG. 16, the second electrode of the fourteenth transistor M14 of the third exemplary holding latch 503 may be connected with the first input terminal clk.

Referring to FIGS. 14 and 16, during the first period T1, the fourteenth transistor M14 may be turned on as a result of a voltage level supplied from the input unit 202. During this time, because a low level voltage may be supplied to the first clock terminal /clk, the low level voltage may be supplied to the gate electrode of the twelfth transistor M12 via the fourteenth transistor M14, and may thereby turn on the twelfth transistor 12. During the second period T2, a high level voltage may be supplied from the input terminal 202 to the gate electrode of the fourth transistor M14, and thus, the fourteenth transistor M14 may be turned off during the second period T2, the third period T3 and the fourth period T4.

That is, in embodiments of the invention, the third exemplary holding latch 503 may be driven in the same manner of the first exemplary holding latch 501.

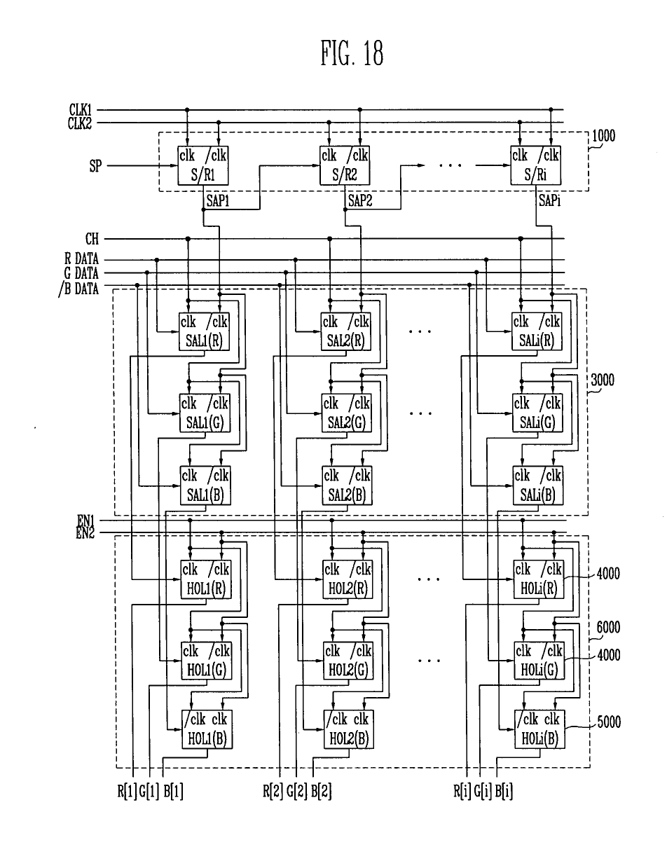

FIG. 17 illustrates a circuit diagram showing a fourth exemplary embodiment of a holding latch 504 employable by the exemplary holding latch unit 500 shown in FIG. 11. In the following description of the fourth exemplary holding latch 504, only differences between the fourth exemplary holding latch 503 and the first, second and third exemplary holding latches 501, 502, 503 shown in FIGS. 13, 15 and 16 will be described.

Referring to FIG. 17, the second electrode of the seventeenth transistor M17 of the fourth exemplary holding latch 504 may be connected with the second power source VSS. As described above, although the second electrode of the seventeenth transistor M17 may be connected with the second power source VSS, operation thereof may be the same as that described with reference to the first exemplary holding latch 501.

FIG. 18 illustrates a diagram of a third exemplary embodiment of a connection scheme for a shift register unit, a sampling latch unit and a holding latch unit employable by the data driver 20 shown in FIG. 4. In the following description of the third exemplary connection scheme illustrated in FIG. 18, only differences between the third exemplary embodiment and the first and second exemplary embodiments described above with reference to FIGS. 5 to 10 and 11-17 will be described. Thus, in the following description the same reference numerals will be used for like elements, and a detailed description of the like elements and/or the operation thereof will be omitted.

More particularly, FIG. 18 illustrates an exemplary embodiment in which red data, green data and blue data are simultaneously input from an external source (not shown) as sequential portions of data DATA.

In other words, the first and second exemplary embodiments shown in FIG. 5 and FIG. 11 are exemplary embodiments in which red data RDATA, green data GDATA and blue data BDATA are sequentially input, whereas in the third exemplary embodiment shown in FIG. 18, the red data RDATA, the green data GDATA and the blue data BDATA are simultaneously input.

As shown in FIG. 18, a shift register 1000 may include i shift registers S/R1 to S/Ri, where i may be a natural number. A sampling latch unit 3000 may include 3i sampling latches SAL1(R) to SALi(R), SAL1(B) to SALi(B) and SAL1(G) to SALi(G), and a holding latch unit 6000 may include 3i holding latches HOL1(R) to HOLi(R), HOL1(B) to HOLi(B) and HOL1(G) to HOLi(G).

Each holding latch HOL1(R) to HOLi(R), HOL1(B) to HOLi(B) and HOL1(G) to HOLi(G) of the holding latch unit 6000 may correspond to any of the exemplary embodiments illustrated in FIGS. 9 to 12 and 13 to 17.

In the exemplary embodiment shown in FIG. 18, holding latches 5000, corresponding to, e.g., holding latches HOL1(R) to HOLi(R) and HOL1(G) to HOLi(G) for the red data RDATA and the green data GDATA may correspond to the exemplary embodiments shown in FIG. 13 to FIG. 17, and holding latches 4000 corresponding to, e.g., holding latches HOL1(B) to HOLi(B) for the blue data BDATA may correspond to the exemplary embodiments shown in FIG. 9 and FIG. 12. Embodiments of the invention are not limited to such an embodiment.

Accordingly, in the third exemplary embodiment, the blue data may be input as inverse phase blue data /BDATA, and the red and green data may be input as non-inverse phase red and green data RDATA and GDATA.

Odd numbered shift registers, e.g., S/R1, S/R3, of the shift registers S/R1 to S/Ri of the shift register unit 1000 may receive the first clock signal CLK1 through the first input terminal clk, and may receive the second clock signal CLK2 through the second input terminal /clk. Even numbered shift registers, e.g., S/R2, S/R4, of the shift registers S/R1 to S/Ri may receive the second clock signal CLK2 through the first input terminal clk, and may receive the first clock signal CLK1 through the second input terminal /clk.

A first shift register S/R1 of such shift registers S/R1 to S/Ri may generate a first sampling pulse SAP1 by receiving the first clock signal CLK1, the second clock signal CLK2 and the start pulse SP. The second shift register S/R2 may generate a second sampling pulse SAP2 by receiving the first clock signal CLK1, the second clock signal CLK2 and the first sampling pulse SAP1. Through such a process the shift registers S/R1 to S/Ri may sequentially generate the sampling pulses SAP1 to SAPi and may supply them to the sampling latches of the sampling latch unit 3000. Meanwhile, each of the shift registers S/R1 to S/Ri may correspond to that shown, e.g., in FIG. 7 and thus, detailed description thereof will be omitted.

The sampling latches SAL may receive the charging signal CH through the first input terminal clk, and may receive the respective sampling pulse SAP through the second input terminal /clk. The respective sampling latch SAL receiving the respective sampling pulse SAP and the charging signal CH may store the respective data supplied thereto, and may sustain the stored data for a predetermined period.

In embodiments, the sampling latches SAL may include red sampling latches SAL1(R) to SALi(R) receiving the red data RDATA, green sampling latches SAL1(G) to SALi(G) receiving the green data GDATA and blue sampling latches SAL1(B) to SALi(B) receiving the inverse phase blue data /BDATA.

When the sampling pulse SAP and the charging signal CH are supplied, the red sampling latches SAL1(R) to SALi(R) may receive the red data RDATA and may store the respective data for a while. When the sampling pulse SAP and the charging signal CH are supplied, the green sampling latches SAL1(G) to SALi(G) may receive the green data G Data and may store the respective data for a while. When the sampling pulse SAP and the charging signal CH are supplied, the blue sampling latches SAL1(B) to SALi(B) may receive the inverse phase blue data /BDATA and may store the respective data for a while.

One of each of the red sampling latches SAL(R), one of the green sampling latches SAL(G) and one of the blue sampling latches SAL(B) may form one group, and the respective red sampling latch SAL(R), the respective green sampling latch SAL(G) and the respective blue sampling latch SAL(B) included in each respective group may receive the same sampling pulse SAP and charging signal CH. Therefore, the respective red sampling latch SAL(R), the respective green sampling latch SAL(G) and the respective blue sampling latch SAL(B) included in the same group may simultaneously or substantially simultaneously receive the respective data RDATA, GDATA and /BDATA. In embodiments of the invention, a number of the sampling latches SAL included in the sampling latches SAL may be three times more than the number of the shift registers S/R. Each of the sampling latches may correspond to, e.g., the exemplary embodiment illustrated in FIG. 8, and thus a detailed description thereof will be omitted.

Meanwhile, the holding latch unit 4000 may include the red holding latches HOL1(R) to HOLi(R) receiving the red data RDATA, the green holding latches HOL(G) to HOLi(G) receiving the green data GDATA and the blue holding latches HOL1(B) to HOLi(B) receiving the inversed blue data /BDATA.

That is, the red holding latches HOL(R)1 to HOLi(R) may receive the red data RDATA from the red sampling latches SAL1(R) to SALi(R), the green holding latches HOL(G) to HOLi(G) receive the green data GDATA from the green sampling latches SAL1(G) to SALi(G), and the blue holding latches HOL1(B) to HOLi(B) may receive the inverse phase blue data /BDATA from the blue sampling latches SAL1(B) to SALi(B). Thus, a number of the holding latches may be the same as the number of sampling latches SAL.

However, the red and the green holding latches HOL(R)1 to HOLi(R), HOL(G) to HOLi(G) may receive the second enable signal EN2 through the first input terminal clk and may receive the first enable signal EN1 through the second input terminal /clk, and the blue holding latches HOL1(B) to HOLi(B) may receive the first enable signal EN1 through the first input terminal clk and receive the second enable signal EN2 through the second input terminal /clk.

The holding latches HOL receiving the first enable signal EN1 and the second enable signal EN2 may simultaneously receive the respective data RDATA, GDATA and /BDATA stored in the respective sampling latches SAL, and the holding latches HOL may supply each of the red, green and blue data RDATA, GDATA, BDATA to the respective data lines D1 to Di as a first data signal or a second data signal corresponding to a polarity of the stored data RDATA, GDATA, /BDATA.

In embodiments, each of the red and green holding latches HOL(R)1 to HOLi(R), HOL(G) to HOLi(G) may be the same that as shown, e.g., in FIG. 9 and each of the blue holding latches HOL1(B) to HOLi(B) may be the same with that as shown, e.g., in FIG. 13, and thus, detailed descriptions thereof will be omitted.

The detailed description and the drawings of the present invention are illustrated, by way of example, to describe the present invention, rather than limiting the meanings of the present invention or the scope of the present invention defined in the claims.

Although a few embodiments of the present invention have been shown and described, it would be appreciated by those skilled in the art that changes might be made in this embodiment without departing from the principles and spirit of the invention, the scope of which is defined in the claims and their equivalents.

As described above, according to a data driver and an organic light emitting display employing one or more aspects of the invention, shift registers, sampling latches and holding latches included in a data driver may be configured of only P-type, e.g., PMOS transistors and thus, may enable a data driver can be mounted on a panel and a manufacturing expense to be reduced accordingly. Also, in embodiments of the invention a data driver may supply a first data signal or a second data signal as a data signal, and thus, embodiments of the invention may be employed for driving an organic light emitting display in a digital manner.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A data driver, comprising:
a shift register unit receiving a first clock signal, a second clock signal and a start pulse and outputting a sampling pulse;
a sampling latch unit storing data based on the sampling pulse and a charging signal; and
a holding latch unit receiving data stored in the sampling latch unit based on a first enable signal and a second enable signal and supplying a first data signal or a second data signal to data lines based on the data received from the sampling latch unit.

2. The data driver as claimed in claim 1, wherein the charging signal has a high level when the data is input to the sampling latch unit.

3. The data driver as claimed in claim 1, wherein the shift register unit includes i shift registers, the i shift registers sequentially generating the sampling pulse, wherein i is a natural number.

4. The data driver as claimed in claim 1, wherein the sampling latch unit includes i sampling latches and the holding latch unit includes i holding latches, wherein i is a natural number.

5. The data driver as claimed in claim 1, wherein a phase of the first clock signal is opposite to a phase of the second clock signal.

6. The data driver as claimed in claim 5, wherein the first clock signal and the second clock signal both have a high level during at least one predetermined period of time.

7. The data driver as claimed in claim 1, wherein each of the shift register unit, the sampling latch unit and the holding latch unit includes:
a first transistor with a gate electrode connected to a second input terminal, a first electrode connected to an external input terminal, and a second electrode connected to a first node;
a second transistor with a gate electrode connected to the first node, a first electrode connected to a first input terminal, and a second electrode connected to an output terminal;
a third transistor with a gate electrode connected to the first input terminal, a first electrode connected to a second node, and a second electrode connected to one of a second power source and the first input terminal;
a fourth transistor with a gate electrode connected to the first node, a first electrode connected with the second input terminal, and a second electrode connected to the second node;
a fifth transistor with a gate electrode connected to the second node, a first electrode connected to a first power source, and a second electrode connected to the output terminal; and
a capacitor connected between a gate electrode of the second transistor and the second electrode of the second transistor, wherein the first power source has a voltage higher than that of the second power source.

8. The data driver as claimed in claim 7, wherein the first, second, third, fourth and fifth transistors are p-type transistors.

9. The data driver as claimed in claim 7, wherein at least one of:
odd numbered ones of the shift registers receive the first clock signal through the first input terminal, and receive the second clock signal through the second input terminal, and
even numbered ones of the shift registers receive the second clock signal through the first input terminal, and receive the first clock signal through the second input terminal.

10. The data driver as claimed in claim 7, wherein the shift registers charge a voltage corresponding to a voltage externally supplied in the capacitor when a low level voltage is supplied to the second input terminal, and supply a voltage corresponding to the voltage stored in the capacitor to the output terminal when a high level voltage is supplied to the second input terminal.

11. The data driver as claimed in claim 7, wherein the sampling latches receive the sampling pulse through the second input terminal, and receive the charging signal through the first input terminal.

12. The data driver as claimed in claim 11, wherein the sampling latches receive the data when the sampling pulse has a low level, and output the data when the sampling pulse is stopped and the charging signal has a high level.

13. The data driver as claimed in claim 7, wherein the holding latches receive the first enable signal through the second input terminal, and receive the second enable signal through the first input terminal.

14. The data driver as claimed in claim 13, wherein a phase of the first enable signal is opposite to a phase of the second enable signal.

15. The data driver as claimed in claim 14, wherein the holding latches receive data from the sampling latches when the first enable signal has a low level, and supply a first data signal or a second data signal to data lines when the first enable signal has a high level.

16. The data driver as claimed in claim 14, wherein the first enable signal is sustained at a high level during a period that the data is stored into the sampling latches, and is changed to a low level after the data is stored into the sampling latches.

17. The data driver as claimed in claim 1, wherein each of the holding latches comprises:
an input unit controlling a voltage supplied to an output unit based on inverse data input to a third input terminal and at least one of the first and second enable signals; and
an output unit controlling an output signal based the voltage supplied from the input unit, and the inverse data input to the third input terminal,
wherein the first enable signal is supplied through a first input terminal and the second enable signal is supplied through a second input terminal.

18. The data driver as claimed in claim 17, wherein the inverse data is supplied to each of the holding latches from the sampling latch unit.

19. The data driver as claimed in claim 17, wherein the output unit comprises:
an eleventh transistor with a first electrode connected a third power source and a second electrode connected to an output terminal of the output unit;
a twelfth transistor with a first electrode connected to the output terminal of the output unit and a second electrode connected to a second power source having a voltage lower than the first power source;
a thirteenth transistor with a gate electrode connected to a gate electrode of the eleventh transistor and a first electrode connected to the second electrode of the eleventh transistor;
a fourteenth transistor with a first electrode connected to a second electrode of the thirteenth transistor, and a second electrode connected to one of the first input terminal or the second power source;
a fifteenth transistor with a first electrode connected to the third input terminal, a second electrode connected with the gate electrode of the eleventh transistor, and a gate electrode connected to the first input terminal;
an eleventh capacitor connected between a gate electrode of the twelfth transistor and the first electrode of the twelfth transistor; and
a twelfth capacitor connected between the gate electrode of the eleventh transistor and the first electrode of the eleventh transistor.

20. The data driver as claimed in claim 19, wherein the input unit comprises:
a sixteenth transistor with a first electrode connected with a gate electrode of the fourteenth transistor of the output unit and a second electrode connected with the first input terminal;
a seventeenth transistor with a first electrode connected to a gate electrode of the sixteenth transistor, a gate electrode connected to the second input terminal, and a second electrode connected to one of the second input terminal or the second power source;
an eighteenth transistor with a gate electrode connected to the third input terminal, a first electrode connected to one of the first input terminal and the first power source, and a second electrode connected with the gate electrode of the sixteenth transistor; and
a thirteenth capacitor connected between the gate electrode of the sixteenth transistor and the first electrode of the sixteenth transistor.

21. The data driver as claimed in claim 20, wherein the output unit further comprises a fourteenth capacitor connected between the output terminal of the output unit and the second power source.

22. The data driver as claimed in claim 20, wherein the eleventh, twelfth, thirteenth, fourteenth, fifteenth, sixteenth, seventeenth, and eighteenth transistors are P-type transistors.

23. The data driver as claimed in claim 1, wherein the sampling latch unit includes 3i sampling latches, and the holding latch unit includes 3i holding latches, wherein i is a natural number.

24. The data driver as claimed in claim 23, wherein:
a twelfth transistor with a first electrode connected to the output terminal of the output unit and a second electrode connected to a second power source having a voltage lower than the first power source;
a thirteenth transistor with a gate electrode connected to a gate electrode of the eleventh transistor and a first electrode connected to the second electrode of the eleventh transistor;
a fourteenth transistor with a first electrode connected to a second electrode of the thirteenth transistor, and a second electrode connected to one of the first input terminal or the second power source;
a fifteenth transistor with a first electrode connected to the third input terminal, a second electrode connected with the gate electrode of the eleventh transistor, and a gate electrode connected to the first input terminal;
an eleventh capacitor connected between a gate electrode of the twelfth transistor and the first electrode of the twelfth transistor; and
a twelfth capacitor connected between the gate electrode of the eleventh transistor and the first electrode of the eleventh transistor.

25. The data driver as claimed in claim 19, wherein the input unit comprises:
a sixteenth transistor with a first electrode connected with a gate electrode of the fourteenth transistor of the output unit and a second electrode connected with the first input terminal;
a holding latch unit receiving data stored in the sampling latch unit based on a first enable signal and a second enable signal, and supplying the first data signal or a second data signal to data lines based on external data supplied to the light emitting display.
